(19) United States
(12) Patent Application Publication
(10) Pub. No.: US 2013/0264896 A1
(43) Pub. Date: Oct. 10, 2013

(54) MOLDED STRUCTURAL BODY AND MOTOR HAVING SAME

(71) Applicants: Masanori Morita, Osaka (JP); Kenji Kondo, Nara (JP); Seiji Kurozumi, Osaka (JP)

(72) Inventors: Masanori Morita, Osaka (JP); Kenji Kondo, Nara (JP); Seiji Kurozumi, Osaka (JP)

(73) Assignee: PANASONIC CORPORATION, Kadoma-shi, Osaka (JP)

(21) Appl. No.: 13/995,053

(22) PCT Filed: Sep. 29, 2011
(86) PCT No.: PCT/JP2011/005493

§ 371 Date: Jun. 17, 2013

(30) Foreign Application Priority Data
Dec. 17, 2010 (JP) 2010-281593

(51) Int. Cl. H02K 5/24; H01F 27/02

(52) U.S. Cl. CPC H02K 5/24; H01F 27/022
USPC 310/51; 336/90

(57) ABSTRACT

A molded structural body is obtained by mold forming of a magnet coil wound on an iron core with the use of a molding resin containing at least a thermosetting resin, a thermoplastic resin incompatible with the thermosetting resin, and a metal hydrate having an electrical insulation property, wherein the molding resin has a thermal conductivity of 1.5 W/m·K or more and an excellent frame retardancy of UL94V-0. The molded structural body can achieve a small-size, thin, and high-power device with flame retardancy achieved, without containing any substances with high environmental burdens in the molding resin.

### TECHNICAL FIELD

The present invention relates to a molded structural body obtained by mold forming of a magnet coil wound on an iron core.

### BACKGROUND ART

Motors, transformers, etc. for household electrical appliances are required to be low-vibration and low-noise motors and transformers, in relation to the usage environment of the appliances.

In order to meet this requirement, a molded structural body has been proposed which is obtained by mold forming of a magnet coil wound on an iron core with the use of a molding resin.

A motor for household electrical appliances will be described below as a typical molded structural body with reference to FIG. 1.

A stator is configured to have winding wire 2 wound over iron core 1 with a winding frame interposed therebetween, and integrally formed to be surrounded by molding resin 3, except the inner periphery of iron core 1. In addition, driving circuit 4 is placed between winding wire 2 and bearing 5a, and integrally formed along with the stator to be surrounded by molding resin 3. The inside from the inner periphery of iron core 1 of the stator serves as a space for housing rotor 6. In addition, a bearing housing for housing bearing 5a for rotatably supporting rotor 6 is integrally formed with molding resin 3 on one end surface of the stator. The other end surface of the stator serves as an opening, which is covered, after inserting rotor 6, by bracket 9 which has a bearing housing section housing bearing 5b. Rotor 6 has, on the outer periphery thereof, permanent magnet 7, shaft 8 is pressed into rotor 6, and shaft 8 is rotatably supported on the stator via bearings 5a and 5b.

The above configured motor can provide a motor which is less likely to vibrate and highly silent, because the vibration generated by iron core 1 and winding wire 2 is suppressed by molding resin 3 covering iron core 1 and winding wire 2.

However, in recent years, due to rising of environmental awareness in the market, there have been increasing demands for not only a reduction in size and thickness and an increase in output power density for motors, but also safety and low environmental burdens. For this reason, molding resins have been also requiring the function of suppressing an increase in temperature while achieving the reduction in size, and to that end, non-conventional high thermal conductivity is required. In addition, while it is necessary to have both high withstand voltage performance and flame retardancy in order to ensure the safety, the use of a halogen-based flame retardant such as bromine, which has been used conventionally, will increase the burden on the environment. For this reason, the use of flame retardants with reduced burdens on the environment has been required.

Patent Literature 1 discloses a molding resin containing an unsaturated polyester resin, a thermoplastic resin, and a filler which has a high thermal conductivity, for the purposes of increasing the thermal conductivity of the molding resin and dimensionally stabilizing the resin.

Patent Literature 2 discloses a molding resin containing from 65% to 80% of hard-burned magnesia in an unsaturated polyester resin, for the purpose of increasing the thermal conductivity. Patent Literature 3 discloses a molding resin containing alumina and red phosphorus in an unsaturated polyester resin, for the purposes of increasing the thermal conductivity and improving the flame retardancy. Patent Literature 4 discloses a molding resin containing a metal powder in an epoxy resin, for the purpose of increasing the thermal conductivity.

However, Patent Literature 1 fails to disclose any molding resin which satisfies a reduction in shrinkage factor, an increase in thermal conductivity, and the flame retardancy at the same time.

In addition, as in the invention described in Patent Literature 2, the compounded molding resin of the unsaturated polyester resin filled with 65% or more of the hard-burned magnesia filler which has a high thermal conductivity has difficulty in ensuring the flame retardancy required for molding resins in motors, transformers, etc. for household electrical appliances. Furthermore, as in the invention described in Patent Literature 3, the molding resin of the unsaturated polyester resin filled with the alumina filler which has a high thermal conductivity and provided with flame retardancy with the use of the red phosphorus has problems such as mold corrosion caused by gas generated during the molding and a failure to be admitted as an environment-conscious product because of containing phosphorus. Moreover, when the molding resin is used which contains the metal powder in the epoxy resin as in the invention described in Patent Literature 4, it is difficult to uniformly disperse a filler by kneading, because of the high viscosity of the epoxy resin itself In order to uniformly disperse the filler, it is necessary to control the molecular weight of the epoxy resin, or there are problems such as longer production takt time due to the limited kneading method. In addition, the conductive metal powder is incorporated between the winding wires in the mold forming of the magnet coil wound on the iron core, and thus, if there are any pinholes nearby in the film of the winding wire, the dielectric voltage of the molded structural body may be decreased in some cases. Furthermore, because the molding resin is filled with the metal powder, there is a problem that the mold is damaged in a short period of time in the mold forming.
PTL 1: Unexamined Japanese Patent Publication No. 2001-226573
PTL 2: Japanese Patent No. 3622724
PTL 3: Japanese Patent No. 4186930
PTL 4: Unexamined Japanese Patent Publication No. 2004-143368

### SUMMARY OF THE INVENTION

The present invention is intended to solve the conventional problems, and provides a molded structural body obtained by mold forming of a magnet coil wound on an iron core with the use of a molding resin, wherein the molding resin comprises at least a thermosetting resin, a thermoplastic resin incompatible with the thermosetting resin, and an inorganic filler containing a metal hydrate, and has a thermal conductivity of 1.5 W/m·K or more from the molding, and achieving frame retardancy of UL94V-0.

An embodiment of the molded structural body according to the present invention is a molded structural body wherein the thermosetting resin is an unsaturated polyester resin, and the compounding amount of the metal hydrate is equal to or more than two times the total compounding amount of the unsaturated polyester resin and the thermoplastic resin.

Another embodiment of the molded structural body according to the present invention is the molded structural body wherein the thermoplastic resin is a styrene-based resin which is incompatible with the unsaturated polyester resin.

Another embodiment of the molded structural body according to the present invention is the molded structural body wherein the compounding amount of the styrene-based resin ranges from 11 parts by weight but no more than 67 parts by weight with respect to 100 parts by weight of the unsaturated polyester resin in the molding resin.

Another embodiment of the molded structural body according to the present invention is the molded structural body wherein the inorganic filler contained in the molding resin ranges from 70 to 80% by weight inclusive.

The present invention also relates to a motor including the molded structural body obtained by mold forming with the molding resin.

The molded structural body according to an embodiment of the present invention has the molding resin containing the low-viscosity unsaturated polyester resin and the thermoplastic resin incompatible with the unsaturated polyester resin, thereby achieving the effects of improving adhesion and thermal conductivity between the inorganic filler and the resin. Furthermore, among thermoplastic resins, the styrene-based resin has the effect of a reduction in shrinkage, and thus can also improve the dimensional stability.

In addition, the use of the metal hydrate as the inorganic filler for use in the molding resin makes it possible to impart flame retardancy of UL94V-0, without containing any substances with high environmental burdens in the product.

The molded structural body obtained by mold forming with the molding resin is excellent in thermal conductivity, and thus able to provide a highly safe molded motor that is less likely to decrease the reliability due to an increase in temperature and unlikely to burn out.

### BRIEF DESCRIPTION OF THE DRAWINGS

FIG. 1 is a cross-sectional view of a molded motor.

FIG. 2 is a graph showing the relationship between the winding wire temperature and the thermal conductivity of a molding resin in a small-size air-conditioning motor according to an embodiment of the present invention.

### DETAILED DESCRIPTION OF THE PREFERRED EMBODIMENT(S)

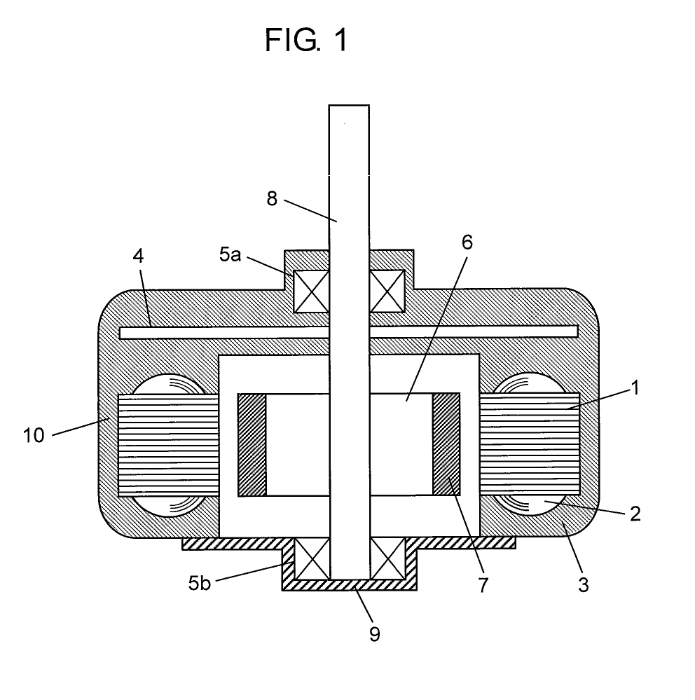

A molded motor according to an embodiment of the present invention will be specifically described with reference to FIG. 1.

The molded motor in FIG. 1 includes a stator having winding wire 2 wound on iron core 1 with a winding frame interposed therebetween, and rotor 6 provided with permanent magnet 7 and housed inside the inner periphery of the stator. Further, this molded motor includes shaft 8 pressed into rotor 6, bearings 5a and 5b for shaft 8, a bearing housing for housing bearing 5a, and bracket 9 which has a bearing housing section for housing bearing 5b. Furthermore, driving circuit 4 is placed between winding wire 2 and bearing 5a. The stator excluding the inner periphery of iron core 1, the bearing housing for housing bearing 5a, and driving circuit 4 are integrally formed with molding resin 3. For the molding, with the stator, bearing housing, and driving circuit set in a mold, and the molding resin is injected, and cured by heating. Used as the mold is a mold designed so that the inner periphery of the stator is not subjected to the resin molding.

The molding resin as a feature of the molded structural body shown in FIG. 1 will be described below.

The molding resin for use in the molded structural body according to the present invention contains a thermosetting resin, a thermoplastic resin, and an inorganic filler containing a metal hydrate.

Examples of the thermosetting resin include epoxy resins, unsaturated polyester resins, and phenolic resins, unsaturated polyester resins are preferred in terms of low viscosity and insulation for the magnet coil, and above all, epoxy-modified unsaturated polyester resins are particularly preferred which are obtained by treatment of unsaturated polyester with epoxy.

The unsaturated polyester resin composition for use as the molding resin according to the present invention will be described below.

### (Unsaturated Polyester Resin Composition)

The unsaturated polyester resin composition according to the present invention includes at least an unsaturated polyester resin, a polymerization initiator, a thermoplastic resin, and an electrically insulating metal hydrate, and other additives may be further added to the composition.

The unsaturated polyester resin, for which an unsaturated polyester resin obtained by an esterification reaction of a polyhydric alcohol component with a saturated and/or unsaturated polybasic acid component can be used without any particular limitation, is preferably further subjected to treatment with epoxy to obtain an epoxy-modified unsaturated polyester resin. In addition, addition-polymerizable monomers can be compounded as a cross-linking agent.

Examples of the polyhydric alcohol used include ethylene glycol, propylene glycol, diethylene glycol, dipropylene glycol, neopentyl glycol, 1,3-butanediol, 1,6-hexanediol, hydrogenated bisphenol A, bisphenol A propylene oxide compounds, and dibromo neopentyl glycol.

Examples of the unsaturated polybasic acid include maleic anhydride, fumaric acid, itaconic acid, and citraconic acid.

Examples of the saturated polybasic acid include phthalic anhydride, isophthalic acid, terephthalic acid, adipic acid, sebacic acid, tetrahydrophthalic anhydride, methyltetrahydrophthalic anhydride, endomethylenetetrahydro phthalic anhydride, Het acid, and tetrabromophthalic anhydride.

Examples of the addition-polymerizable monomers include styrene, diallyl phthalate, methyl methacrylate, vinyl acetate, vinyl toluene, α-methyl styrene, methyl acrylate, 2-hydroxyethyl acrylate, and 2-hydroxyethyl methacrylate. The compounding amount of the addition-polymerizable monomer preferably ranges from 25% by weight to 75% by weight in the mixture of the unsaturated polyester and the addition-polymerizable monomer, in terms of the mechanical strength of the cured product and the shrinkage factor during the curing period. Hereinafter, the mixture of the unsaturated polyester and the addition-polymerizable monomer may be referred to as an unsaturated polyester resin. It is also possible to use injection molding grades of commercially available unsaturated polyester resins available from Japan U-Pica Company Ltd., Hitachi Chemical Company, Ltd., Showa Highpolymer Co., Ltd., DH Material Inc., etc.

In terms of ensuring favorable kneadability and reducing shrinkage, the viscosity of the unsaturated polyester resin at 25° C. preferably ranges from 100 mPa·s to 2000 mPa·s, and more preferably from 100 mPa·s to 1000 mPa·s.

For example, benzoyl peroxide, methyl ethyl ketone peroxide, t-butyl peroxybenzoate, t-butylperoxy-2-ethylhexanoate, t-butyl peroxyisopropylcarbonate, 1,1-di(t-butylperoxy)cyclohexane, 1,1-di-t-butylperoxy-3,3,5-trimethylcyclohexanoate, etc. can be used as the polymerization initiator. The compounding amount of the polymerization initiator preferably ranges from 0.1% by weight to 2% by weight, which is a compounding range for ensuring the preservation stability of the molding resin and achieving favorable polymerization reactivity. Furthermore, curing accelerators such as cobalt naphthenate can be used in combination.

Styrene-based resins such as polystyrene, styrene-acrylonitrile copolymers (AS), acrylonitrile-butadiene-styrene copolymers (ABS), styrene-butadiene copolymers, vinyl acetate-styrene-based block copolymers, and methyl methacrylate-styrene-based block copolymers; acrylic resins such as polymethyl methacrylate and methyl methacrylate-multifunctional methacrylate copolymers; polycaprolactone; polypropylene adipate; polydipropylene isophthalate, etc. can be used as the thermoplastic resin added to the unsaturated polyester resin. The thermoplastic resin is preferably an incompatible thermoplastic resin that is not compatible with the unsaturated polyester resin, more preferably a styrene-based resin that is incompatible with the unsaturated polyester resin, and above all, in particular, preferably a styrene-based resin which has a lower molecular weight.

The compounding amount of the thermoplastic resin preferably ranges from 10 parts by weight to 70 parts by weight with respect to 100 parts by weight of the unsaturated polyester resin. The compounding amount more preferably ranges from 11 parts by weight to 67 parts by weight, and most preferably from 25 parts by weight to 67 parts by weight. The range from 10 parts by weight to 70 parts by weight achieves an unsaturated polyester resin composition which has kneadability and fluidity, and has suppressed molding shrinkage.

The total compounding amount of the unsaturated polyester resin and the thermoplastic resin in the unsaturated polyester resin composition preferably ranges from 16% by weight to 25% by weight, and more preferably 21% by weight to 25% by weight. The range from 16% by weight to 25% by weight achieves both favorable kneadability and moldability.

Examples of the inorganic filler include aluminum hydroxide, alumina, hydrated alumina, aluminum chloride hydrates, magnesium oxides, aluminum nitrides, silica, boron nitride, clay, calcium carbonate, talc, and bismuth oxide hydrates. In these fillers, the metal hydrate is an essential constituent in terms of thermal conductivity and flame retardancy, and above all, hydrated alumina (that is, aluminum hydroxide) is more preferable. Examples of the aluminum hydroxide herein include hydrated alumina represented by the following formula: Al₂O₃.nH₂O (where n represents 1 to 3). Above all, alumina trihydrate and the like are preferable.

The compounding amount of the inorganic filler preferably ranges from 70% by weight to 80% by weight in the unsaturated polyester resin composition. When the compounding amount ranges as mentioned above, the unsaturated polyester resin composition has favorable kneadability. In addition, the compounding amount of the metal hydrate in the inorganic filler is twice or more times as large as the total compounding amount of the unsaturated polyester resin and the thermoplastic resin. This can ensure the flame retardancy of UL94V-0. The specific surface area of the inorganic filler is preferably 5 m²/g or less, and more preferably 2 m²/g or less, in terms of dispersibility in the unsaturated polyester resin and the like.

The inorganic filler may be subjected to a surface treatment with a silane coupling agent. Examples of the silane coupling agent include N-(2-aminoethyl)aminopropyltrimethoxysilane, N-(2-aminoethyl)aminopropylmethyldimethoxysilane, 3-glycidoxypropylmethyldimethoxysilane, 3-glycidoxypropyltriethoxysilane, and 3-methacryloxypropyltrimethoxysilane. The additive amount of the silane coupling agent preferably ranges from 0.1% by weight to 0.5% by weight in the unsaturated polyester resin. The range mentioned above can improve the adhesion between the resin and the inorganic filler, and suppress a decrease in the strength of the molding resin due to an excess of coupling agent.

The unsaturated polyester resin composition according to the present invention may further contain, if necessary, internal mold release agents such as zinc stearate, pigments, polymerization inhibitors, antioxidants, and fillers such as glass fibers, etc.

In the unsaturated polyester resin composition according to the present invention, the composition containing the inorganic filler and a glass fiber can be also uniformly dispersed with the use of a common kneading machine (the blade shape is dual-armed, sigma-form, z-form, or the like).

In contrast, in the case of using an epoxy resin with a high viscosity of 3000 mPa·s as the molding resin, it is difficult to uniformly disperse the inorganic filler and glass fiber contained therein even when a kneading machine is used for kneading the resin. If the epoxy resin is kneaded for a long period of time in order to disperse the inorganic filler and the glass fiber, friction heat will cause curing, and the molding resin is unlikely made to be incorporated between the winding wires during the mold forming. Therefore, even when the molding resin itself has a high thermal conductivity, as the molding structural body, an increase in the temperature of the winding wire may be insufficiently suppressed, or the vibration-proofing property may be decreased.

In addition, the molding resin according to the present invention, which contains no conductive material such as metal powders, is composed of an insulating resin and an insulating inorganic filler. For this reason, even when the inorganic filler is incorporated between covered electric wires of the winding wire during the mold forming, a decrease in dielectric voltage can be suppressed which is caused by defects (initial pinholes and winding scars) on the covered electric wires, and the molded structural body as a whole can ensure a high dielectric voltage.

A mold forming method of setting an object to be subjected to molding, such as a motor, in the mold described above and then injecting and curing the molding resin can be used as the molding method. The molding resin is subjected to molding within two weeks, and more preferably within a week, after kneading.

Measurement methods will be described below.

### <Flame Retardancy Test Method>

The flame retardancy test method for the molding resin was implemented in conformity with the known UL94 standard. Flames from a gas burner were brought into contact with the lower end of a vertically held sample of 1/16 inches thick for 10 seconds, and when combustion was stopped within 30 seconds, the flames were further brought into contact with the lower end for 10 seconds. Each sample tested was ranked as any one of UL94V-0, V-1, and V-2 in accordance with the known criteria for determination.

### <Measurement Method for Thermal Conductivity>

The prepared unsaturated polyester resin composition was filled into a mold subjected to a mold release treatment by heating and application of pressure, and cured by keeping the composition in a constant-temperature bath at 100° C. to 150° C. for 1 hour to 4 hours to obtain a plate-like molded product 200 mm square and 10 mm thick. The thermal conductivity of the cured product was measured by a heat flowmeter method based on JIS A-1412-2.

### <Measurement Method for Viscosity>

The viscosity of the unsaturated polyester resin at 25° C. was measured under the condition of 10 rpm as revolutions per minute with the use of a BHII-type viscometer (manufactured by Toki Sangyo Co., Ltd.).

### <Measurement Method for Specific Surface Area>

The specific surface area of the aluminum hydroxide was measured by a nitrogen adsorption method (BET method).

### <Measurement Method for Winding Wire Temperature>

For the winding wire temperature of the magnet coil, the winding wire resistance was measured immediately after shutdown with the use of a resistance tester (Digital HiTester 3223 manufactured by HIOKI E.E. CORPORATION), and the winding wire temperature during operation was estimated by a resistance method.

### <Evaluation Method for Dimensional Stability>

For the measurement of the molding shrinkage factor, a shrinkage disk specified in JIS K6911 was subjected to compression molding at a molding temperature of 150° C. under a molding pressure of 10 MPa for a molding time of 3 minutes to calculate the molding shrinkage factor based on JIS K6911. The dimensional stability was defined as follows: “favorable”: molding shrinkage factor less than 0.12%, “Δ”: molding shrinkage factor ranging from 0.12% to 0.2%, “x”: molding shrinkage factor more than 0.2%.

### <Evaluation of Compatibility Between Unsaturated Polyester Resin and Thermoplastic Resin>

Table 1 shows compatibility for mixtures of various types of thermoplastic resins compounded with the unsaturated polyester resin, and the thermal conductivity for prepared molded products. The determination of compatibility was visually evaluated for the mixtures obtained by mixing and stirring the unsaturated polyester and thermoplastic resins. Here are the criteria for determination:

“incompatible”: the thermoplastic resin in the form of microscopic particles uniformly dispersed in the entire unsaturated polyester resin (white turbidity)

“compatible”: the unsaturated polyester resin forming a homogeneous solution with the thermoplastic resin

“partially compatible”: a mixture of a compatible state and an incompatible state (slight white turbidity)

### (Properties of Molded Structural Body)

The molded structural body according to an embodiment of the present invention, which is obtained by mold forming of the magnet coil wound on the iron core with the use of the unsaturated polyester resin composition has both high radiation performance and safety, because the thermal conductivity of the molding resin molded is 1.5 W/m·K or more, whereas the flame retardancy satisfies UL94V-0 ( 1/16 inches thick).

If the thermal conductivity of the molding resin molded is 1.5 W/m·K or more, an increase in winding wire temperature can be suppressed to 130° C. or lower for the molded structural body obtained by mold forming of the coil, even when the coil generates heat through energization. Moreover, the flame retardancy of UL94V-0 can reduce the thinnest section of the molding resin in thickness, and thus achieve a reduction in size and weight for the molded structural body.

An embodiment of the present invention will be described below with reference to the drawings and tables. The indications in terms of % and parts below, including the descriptions in the figures and tables, respectively represent % by weight and parts by weight, unless otherwise stated.

### First Exemplary Embodiment

In first embodiment, the molded structural body according to the present invention is applied to the molded motor in FIG. 1.

First, 30 parts by weight of the thermoplastic resin was compounded and kneaded with respect to 100 parts by weight of the unsaturated polyester resin to evaluate the compatibility of the mixture.

Thereafter, while keeping the compounding ratio between the unsaturated polyester resin and the thermoplastic resin as described above, a molding resin was prepared which was composed of the compounding amount of the unsaturated polyester resin and the thermoplastic resin: 21% by weight in total, glass fiber: 7% by weight, silane coupling agent (KBE-403 available from Shin-Etsu Chemical Co., Ltd.): 0.2% by weight, 1,1-di(t-butylperoxy)cyclohexane (polymerization initiator): 0.4% by weight, zinc stearate: 1.3% by weight, polymerization inhibitor: 0.1% by weight, and aluminum hydroxide: 70% by weight (specific surface area: 0.9 m²/g), and a test sample was prepared in accordance with the method for measuring the thermal conductivity as described above.

The materials used are as follows:

Unsaturated polyester resin: epoxy-modified polyester resin (Sandoma PB 210) available from Hitachi Chemical Company, Ltd.

Polyester resin: polyester resin (Sandoma PB 987) available from Hitachi Chemical Company, Ltd.

Styrene-based resin “a”: available from Hitachi Chemical Company, Ltd.

Styrene-based resin “b”: available from Hitachi Chemical Company, Ltd.

Acrylic resin “c”: available from Hitachi Chemical Company, Ltd.

Acrylic resin “d”: available from Hitachi Chemical Company, Ltd.

Table 1 shows the evaluation results of compatibility and the measurement results of the thermal conductivity.

TABLE 1

| Type of Thermoplastic | Presence or Absence | Thermal Conductivity |
|---|---|---|
| Resin | of Compatibility | (W/m · K) |
| Polyester Resin | Compatible | 1.1 |
| Styrene-based Resin “a” | Incompatible | 1.5 |
| Styrene-based Resin “b” | Compatible | 1.2 |
| Acrylic Resin “c” | Incompatible | 1.1 |
| Acrylic Resin “d” | Partially compatible | 0.9 |

From Table 1, the styrene-based resin “a” and acrylic resin “c” incompatible with the unsaturated polyester resin respectively have the thermal conductivity increased more than the styrene-based resin “b” and acrylic resin “d” compatible therewith. In particular, the mixture of the unsaturated polyester resin with the styrene-based resin “a” exhibited high thermal conductivity in spite of the other equivalent compounded composition.

Next, Table 2 shows the total compounding amount of the unsaturated polyester resin and the styrene-based resin in the molding resin and the relationship between the compounding amount of aluminum hydroxide and the flame retardancy of the molded resin.

TABLE 2

Sample

| | A | B | C | D |
|---|---|---|---|---|
| Total of Unsaturated | 21% | 21% | 21% | 18% |
| Polyester Resin and | | | | |
| Styrene-based Resin “a” | | | | |
| Aluminum Hydroxide | 35% | 42% | 70% | 75% |
| Calcium Carbonate | 35% | 28% | — | — |
| Glass Fiber | 7% | 7% | 7% | 5% |
| Others | 2% | 2% | 2% | 2% |
| Flame Retardancy of | V-2 | V-0 | V-0 | V-0 |
| UL94 Standard | | | | |

(%: % by weight)

In Table 2, the unsaturated polyester resin is an epoxy-modified unsaturated polyester resin available from Hitachi Chemical Company, Ltd., and a product (no product number) available from Hitachi Chemical Company, Ltd. was used for the styrene-based resin “a” being incompatible with the unsaturated polyester resin. The compounding ratio of the styrene-based resin “a” was adjusted to 30 parts by weight with respect to 100 parts by weight of the unsaturated polyester resin. The product type with a specific surface area of 0.9 m2/g was used for the aluminum hydroxide. The breakdown of “Others” 2% by weight is: silane coupling agent (KBE-403 available from Shin-Etsu Chemical Co., Ltd.) 0.2% by weight; 1,1-di(t-butylperoxy)cyclohexane (polymerization initiator) 0.4% by weight; zinc stearate 1.3% by weight; and polymerization inhibitor 0.1% by weight.

As shown in Table 2, the flame retardancy of UL94V-0 was ensured in the case of the samples B, C, and D in which the compounding amount of aluminum hydroxide contained as a constituent of the inorganic filler was equal to two times or more than two times as large as the total compounding amount of the unsaturated polyester resin and the styrene-based resin “a”. On the other hand, the flame retardancy of UL94V-2 was insufficient in the sample A in which the total compounding amount of the inorganic filler was 70% by weight as in the case of the samples B and C, whereas the compounding amount of aluminum hydroxide was 35% by weight, and less than twice as large as 21% by weight as the total compounding amount of the unsaturated polyester resin and the styrene resin a.

As described above, the molding resin according to a first embodiment can ensure, as a flame retardant, the flame retardancy of UL94V-0 without using any substances such as halogen and phosphorus, which are considered to have high environmental burdens and limited on the use thereof in some products. More specifically, when the molding resin is compounded with aluminum hydroxide which is twice or more times as large as the total compounding amount of the unsaturated polyester resin and the styrene-based resin, the flame retardancy of UL94V-0 can be ensured without containing any substances considered to have high environmental burdens, thereby allowing for a reduction in the size of the molded motor.

Next, Table 3 shows the compounding amount of the styrene-based resin with respect to the unsaturated polyester resin in the unsaturated polyester resin composition, and the relationship between the dimensional stability and the thermal conductivity.

TABLE 3

| | Sample | | | | |
|---|---|---|---|---|---|
| | E | F | G | H | I |
| Unsaturated | 19% | 17% | 13% | 11% | 12% |
| Polyester | (100 parts) | (100 parts) | (100 parts) | (100 parts) | (100 parts) |
| Resin | | | | | |
| Styrene- | 2% | 4% | 8% | 7% | 9% |
| based | (11 parts) | (25 parts) | (67 parts) | (67 parts) | (80 parts) |
| Resin “a” | | | | | |
| Aluminum | 70% | 70% | 70% | 75% | 70% |
| Hydroxide | | | | | |
| Calcium | — | — | — | — | — |
| Carbonate | | | | | |
| Glass Fiber | 7% | 7% | 7% | 5% | 7% |
| Others | 2% | 2% | 2% | 2% | 2% |
| Dimensional | Δ | Favorable | Favorable | Favorable | Favorable |
| Stability | | | | | |
| Thermal | 1.8 | 1.6 | 1.5 | 1.6 | 1.2 |
| Conductivity | | | | | |
| (W/m · K) | | | | | |

(parts: parts by weight, %: % by weight)

In the molding resin used, the total compounding amount of the unsaturated polyester resin (Sandoma PB210 available from Hitachi Chemical Company, Ltd.) and the styrene-based resin “a” ((no product number) available from Hitachi Chemical Company, Ltd.) ranges from 18% by weight to 21% by weight, aluminum hydroxide ranges from 70% by weight to 80% by weight (specific surface area: 0.9 m²/g), glass fiber is 0 or 7% by weight, and the other is 2% by weight [silane coupling agent (KBE-403 available from Shin-Etsu Chemical Co., Ltd.): 0.2% by weight, 1,1-di(t-butylperoxy)cyclohexane (polymerization initiator): 0.4% by weight, zinc stearate: 1.3% by weight, and polymerization inhibitor: 0.1% by weight].

As shown in Table 3, in the case of the sample E in which the compounding amount of the styrene-based resin “a” is 11 parts by weight with respect to 100 parts by weight of the unsaturated polyester resin, the dimensional stability was somewhat insufficient because of the small compounding amount of the styrene-based resin “a” being incompatible with the unsaturated polyester resin. On the other hand, in the case of the sample I in which the compounding amount of the styrene-based resin “a” is 80 parts by weight with respect to 100 parts by weight of the unsaturated polyester resin, the thermal conductivity was insufficient because of the excessive compounding amount of the styrene-based resin “a”. In contrast, in the case of the samples F to H in which the compounding amount of the styrene-based resin “a” falls within the range more than 11 parts by weight and less than 80 parts by weight with respect to 100 parts by weight of the unsaturated polyester resin, the dimensional stability was favorable, the thermal conductivity was as high as 1.5 W/m·K or more, and the kneadability and the moldability were also favorable. In addition, it was found from Tables 2 and 3 that favorable performance was achieved in terms of all of dimensional stability, thermal conductivity, and flame retardancy, when the compounding amount of the incompatible styrene-based resin “a” fell within the range from 25 parts by weight to 67 parts by weight with respect to 100 parts by weight of the unsaturated polyester resin, the compounding amount of the inorganic filler fell within the range from 70% by weight to 80% by weight, and the compounding amount of aluminum hydroxide was twice or more times as large as the compounding amount of the unsaturated polyester resin and styrene-based resin “a”.

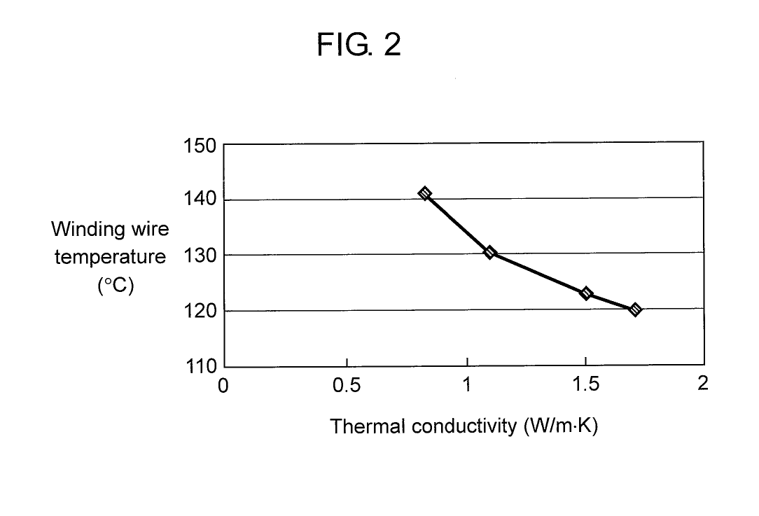

Furthermore, FIG. 2 is a graph showing the relationship between the winding wire temperature and the thermal conductivity of molding resin 3 in the small-size air-conditioning motor in FIG. 1 all configured in the same manner except for molding resin 3, in the case of preparing a molded motor formed in the same shape with the use of a molding resin with different thermal conductivity, and driving the prepared molded motor under the same condition. The increased thermal conductivity of molding resin 3 released heat generated by winding wire 2 more effectively to the outside, thus being capable of suppressing an increase in the temperature of winding wire 2 and an increase in temperature in the respective parts of the motor. Specifically, the thermal conductivity of 1.5 W/m·K or more could keep the winding wire temperature at 125° C. or lower. Thus, the decreased winding wire temperature decreases the temperatures of mounted components on the motor substrate, thereby resulting in an improvement in endurance (cracking resistance) of solder joints used as joints for the mounted components. As a result, a molded motor can be provided which is less likely to break down.

As specifically described above, the first embodiment could ensure the flame retardancy of UL94V-0 when the compounding amount of aluminum hydroxide in the inorganic filler contained in the molding resin in an amount from 70% by weight to 80% by weight was made twice or more times as large as the total compounding amount of the unsaturated polyester resin and the styrene-based resin. In addition, when the compounding amount of the styrene-based resin fell within the range from 11 parts by weight to 67 parts by weight with respect to 100 parts by weight of the unsaturated polyester resin, the dimensional stability and thermal conductivity of the molding resin were both improved.

More specifically, the molding resin according to the first embodiment of the present invention had a thermal conductivity of 1.5 W/m·K or more, and exhibited flame retardancy of 94V-0 ( 1/16 inches thick) in the UL standard. The mold forming for the motor with the use of the molding resin could reduce the thickness of thinnest molding resin section 10, thereby making it possible to achieve a balance between a reduction in the size of the motor and flame retardancy of UL94V-0. The present invention allowed for a reduction in the size and weight of the molded motor, for improvements in reliability, and for improvements in safety, including improvements in endurance of electronic components in driving circuit 4.

### INDUSTRIAL APPLICABILITY

The present invention is used in the field of molded structural body obtained by mold forming in a device including a magnet coil wound on an iron core, e.g., inductor such as choke coils, high voltage transformers such as flyback transformers, and various types of motors, and can be used preferably, in particular, for motors requiring a reduction in size and an increase in output power.

### REFERENCE MARKS IN THE DRAWINGS

1 iron core
2 winding wire
3 molding resin
4 driving circuit
5a, 5b bearing
6 rotor
7 permanent magnet
8 shaft
9 bracket
10 thinnest molding resin section

1. A molded structural body obtained by mold forming of a magnet coil wound on an iron core with a molding resin, wherein the molding resin comprises at least a thermosetting resin, a thermoplastic resin incompatible with the thermosetting resin, and an inorganic filler containing a metal hydrate, and has a thermal conductivity of 1.5 W/m·K or more and frame retardancy of UL94V-0.

2. The molded structural body according to claim 1, wherein the thermosetting resin is an unsaturated polyester resin, and a compounding amount of the metal hydrate is equal to or more than two times a total compounding amount of the unsaturated polyester resin and the thermoplastic resin.

3. The molded structural body according to claim 1, wherein the thermoplastic resin is a styrene-based resin which is incompatible with the unsaturated polyester resin.

4. The molded structural body according to claim 1, wherein a compounding amount of the incompatible thermoplastic resin is more than 11 parts by weight but no more than 67 parts by weight with respect to 100 parts by weight of the thermosetting resin in the molding resin.

5. The molded structural body according to claim 1, wherein the inorganic filler contained in the molding resin ranges from 70 to 80% by weight inclusive.

6. A molded motor comprising the molded structural body according to claim 1.

7. A molded motor comprising the molded structural body according to claim 2.

8. A molded motor comprising the molded structural body according to claim 3.

9. A molded motor comprising the molded structural body according to claim 4.

10. A molded motor comprising the molded structural body according to claim 5.
